(19) United States
(12) Patent Application Publication
(10) Pub. No.: US 2010/0332211 A1
(43) Pub. Date: Dec. 30, 2010

(54) PROGRAMMABLE AND RECONFIGURABLE HARDWARE FOR REAL POWER SYSTEM EMULATION

(75) Inventors: Alexandre OUDALOV, Fislisbach (CH); Yannick MARET, Wettingen (CH); Ira NAGEL, Lausanne (CH); Laurent FABRE, Lausanne (CH); Maher KAYAL, St-Sulpice (CH); Rachid CHERKOUI, Lausanne (CH)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD., Zurich (CH)

(21) Appl. No.: 12/824,513

(22) Filed: Jun. 28, 2010

(30) Foreign Application Priority Data
Jun. 26, 2009 (EP) 09163857.7

(51) Int. Cl. G06F 9/455

(52) U.S. Cl. 703/23

(57) ABSTRACT

An apparatus is provided for emulation of a power system. The apparatus includes a plurality of programmable elements which are selectively connectable to one another. Each programmable element includes at least two elements selected from the group consisting of a generator element, a line element and a load element. A programmable switch element is operable to selectively connect the at least two elements of each programmable element to one another, and to selectively connect the programmable element to one or more other programmable elements. A system, which incorporates the apparatus, is also provided for emulating a power system incorporating such apparatus.

### RELATED APPLICATIONS

This application claims priority under 35 U.S.C. §119 to European Patent Application No. 09163857.7 filed in Europe on Jun. 26, 2009, the entire content of which is hereby incorporated by reference in its entirety.

### FIELD

The present disclosure relates to an apparatus for emulating a power system.

### BACKGROUND INFORMATION

Power system simulation methods have significant computation requirements leading to concerns over the simulation time involved. Nevertheless, international research remains oriented towards the numerical algorithmic approaches applied in simulation methods. This is, at least in part, due to the accuracy of such numerical approaches. However, the speed of such accurate numerical approaches may have reached their limits, particularly where a large stressed power system has to be analyzed within a brief time period.

Research has been carried out to develop an alternative method, using emulation techniques employing electronic circuitry. These techniques seek to rapidly assess the operating point limits of a power system. For example, a power system suddenly facing a critical event can be analyzed, and appropriate decisions can be derived from the emulated system so as to maintain the system viability. However, while the speed of such emulated power system can be faster than for simulated methods using numerical algorithms, the accuracy of such emulations methods can be conventionally lower.

In addition, known power system emulation methods can be limited to a system of reprogrammable power system components and their implementation using digital or analog electronics. However, the topology of the whole system is fixed.

Accordingly, it would be advantageous if there was a flexible and accurate method of emulation, which is of suitable speed to allow rapid assessment of the operating point limits of a power system. Furthermore, it would be advantageous if there was an emulation system in which the overall topology of the system is both provided on a dedicated platform as well as being reprogrammable.

### SUMMARY

An apparatus is disclosed for emulation of a power system, the apparatus comprising: a plurality of programmable elements which are selectively connectable to one another each programmable element comprising: at least two elements selected from the group consisting of a generator element, a line element and a load element; and a programmable switch element, operable to selectively connect the at least two elements of each programmable element to one another, and to selectively connect the programmable element to one or more other programmable elements.

An apparatus is disclosed for emulation of a power system, the apparatus, comprising: a plurality of programmable elements which are selectively connectable to one another, each programmable element comprising: a programmable generator element; a programmable line element; a programmable load element; and a programmable switch element operable to selectively connect the generator element, the line element and the load element, and to selectively connect the programmable element to one or more other programmable elements.

### BRIEF DESCRIPTION OF THE DRAWINGS

Exemplary embodiments of the disclosure will now be described, by way of example only, and with reference to the accompanying drawings, in which:

FIG. 1 illustrates a programmable element of an exemplary embodiment of an apparatus of the present disclosure;

FIG. 2A illustrates a full programmed array of programmable elements of the exemplary embodiment of FIG. 1;

FIG. 2B illustrates an example of a topology configuration of the exemplary embodiment of FIG. 1 after selective programming of the programmable elements within the array of FIG. 2A;

FIG. 3 illustrates the conversion process involved in the selective programming of the programmable elements, the scenario configuration and the configuration of the overall topology of the exemplary embodiment of FIG. 1;

FIG. 4 is an example of a simple power system topology;

FIG. 5 is a table showing the characteristics of the power system of FIG. 4;

FIGS. 6A to 6C illustrate a change in topology of a simple power system within a controlled scenario;

FIGS. 7A and 7B are graphs showing a results comparison for the scenario illustrated in FIG. 6;

FIG. 8 is a table illustrating the results of the critical short circuit time comparison scenario for the power system of FIG. 6 and an equivalent numerical simulation; and

FIG. 9 illustrates an array of power system emulation apparatus in accordance with an exemplary embodiment of the present disclosure.

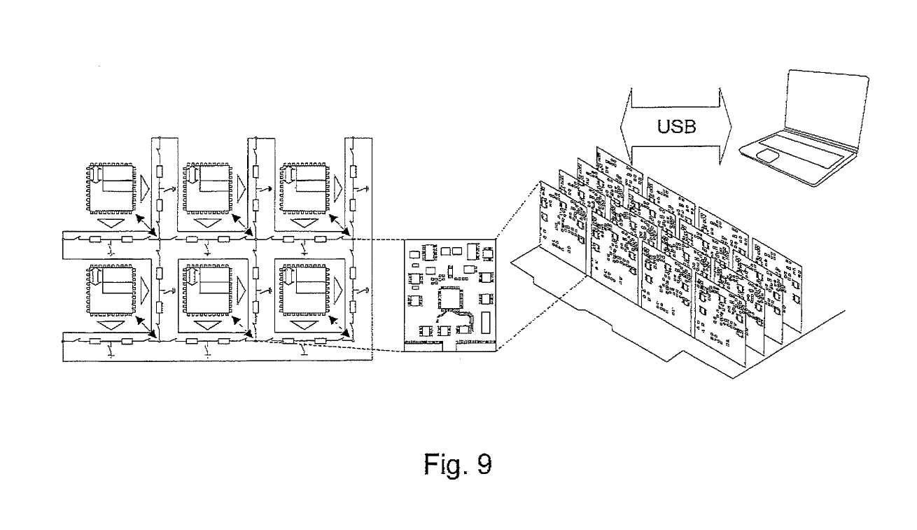

### DETAILED DESCRIPTION

An exemplary embodiment of the present disclosure provides an apparatus for emulation of a power system. The apparatus includes a plurality of programmable elements, which are selectively connectable to one another. Each programmable element includes at least two elements selected from the group consisting of a generator element, a line element and a load element. A programmable switch element is operable to selectively connect the at least two elements of each programmable element to one another, and to selectively connect the programmable element to one or more other programmable elements.

In such an apparatus, for example, at least one programmable element may include a generator element and a line element, and another programmable element may include a load element and a line element.

Another exemplary embodiment of the present disclosure provides an apparatus for emulation of a power system. The apparatus includes a plurality of programmable elements which are selectively connectable to one another. Each programmable element includes a programmable generator element, a programmable line element, a programmable load element, and a programmable switch element which is operable to selectively connect the generator element, line element and load element, and to selectively connect the programmable element to one or more other programmable elements.

The topology of the programmable elements can be selectively emulated based on the operation of the programmable switch element.

The programmable switch element can also be used to emulate different scenarios for the given topology, such as, but not restricted to, a short circuit of the transmission line and the like. As used herein, the term ‘scenarios’ is intended to include localized changes in the topology and/or changes of the programmable element parameters.

Thus, the present disclosure can provide a dedicated interconnected plurality of programmable elements representing basic power network components. Each programmable element contains the necessary components to model a power system including, but not restricted to, generator(s), load(s), transmission and distribution line(s), transformer(s) and other voltage, frequency, active and reactive power flow control devices and the like.

In an exemplary embodiment, the programmable switch element can be operable to selectively alter the connections between the one or more programmable elements.

Alternatively, or in addition, the programmable switch element can be operable to selectively alter the connections between the generator elements, line element (including, but not limited to, the transmission line element) and a load element of each programmable element.

An exemplary apparatus of the present disclosure can utilize microelectronic circuits rather than the numerical algorithms of known digital arrangements. Furthermore, as each programmable element can be selectively programmed, and also selectively connected to other selectively programmable elements, by operation of a programmable switch element, the apparatus of the present disclosure can provide a programmable power system emulator that can simultaneously reproduce a large number of power system phenomena at different time constants and frequencies.

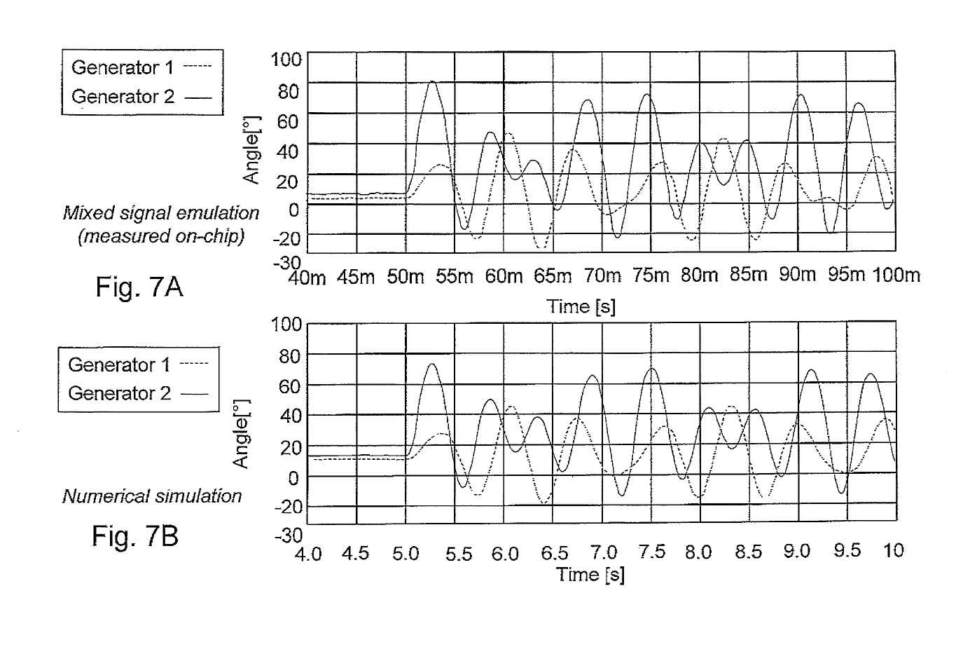

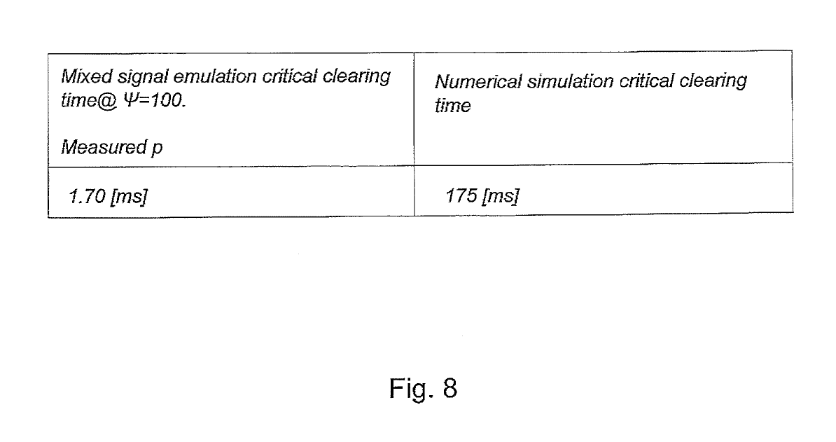

Furthermore, the emulation speed can be faster than real time, so that the effects of disturbances may be analyzed prior to their appearance in real time. For example, FIG. 8 illustrates the increase in terms of speed between real time and an emulated time. It shows that a given scenario can be emulated a hundred times faster than it happens in real time. An additional example of speedup is shown in FIGS. 7A and 7B. For example, a phenomenon having duration of 10 s in real time (FIG. 7B) can take only 100 ms to be emulated (FIG. 7A).

The faster than real time emulation implies the following. Once a fault is detected (for example, the short-circuit happening at 5 s in FIG. 7B), one second of real time can be used to emulate a single scenario taking a hundred seconds in real time or, alternatively, a hundred scenarios each taking one second in real time. Based on the emulation results, the power network can then be steered using those scenarios that ensure its stability.

Faster than real time emulation can also be used to perform pre-emptive stability analysis. Contrary to the preceding example, in this example, no fault occurs. The emulation system can be used to check the effect of faults that could happen. Because emulation can be faster than real time, several scenarios of, for example, one second of duration can be emulated during one second of real time. If one of these pre-emptive scenarios can possibly lead to a downfall of the power network, mitigation actions and contingency plans can be prepared in advance.

The programmable switch element can include one or more selectable switches.

As used herein, the term ‘switches’ can include, for example, an element which electrically isolates/connects two or more other elements together in order to program the topology, and the local topology changes for a scenario definition.

The plurality of programmable elements can be provided on an application specific integration circuit (ASIC). Alternatively, the plurality of programmable elements can be provided for a field programmable gate array, for example, analog and/or digital.

The plurality of programmable elements can be provided as an array. The array can be connected through an analog bus that represents the power grid in a power system. This arrangement can allow improved data transmission speed between programmable elements as the analog bus allows the propagation of waveforms in real time and thus facilitates the mapping between real power system topologies and the electronic emulation.

An exemplary apparatus according to the present disclosure can include two or more such arrays in communication with one another.

An exemplary embodiment of the present disclosure can provide a system for emulating a power system including an apparatus for emulation of a power system as described in the present disclosure, and a controller for receiving user inputs and operable to supply control signals to the apparatus based on received user inputs.

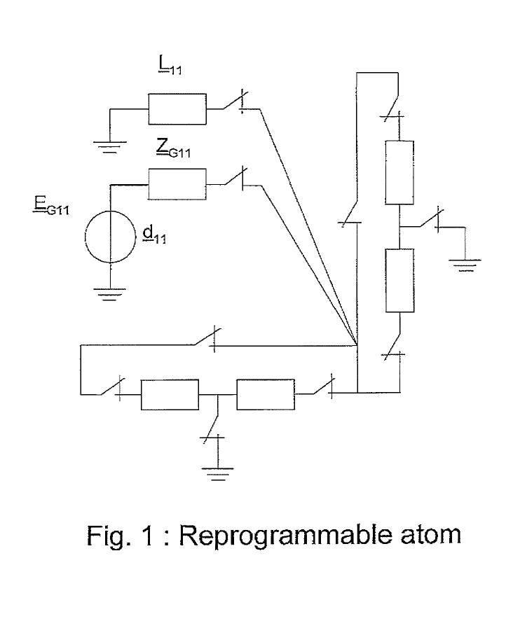

FIG. 1 shows an exemplary embodiment of a programmable element 10 which contains components to model a power system, including a programmable load 12, a programmable generator 14, and a programmable line 16. Switches 18 can be provided between each component within the programmable element 10 to allow a plurality of programmable element topologies to be assumed based on the selective operation of switches 18. It will be appreciated that the programmable element 10 of FIG. 1 is an example provided for illustrative purposes only, and other power system components can also be included with power element 10.

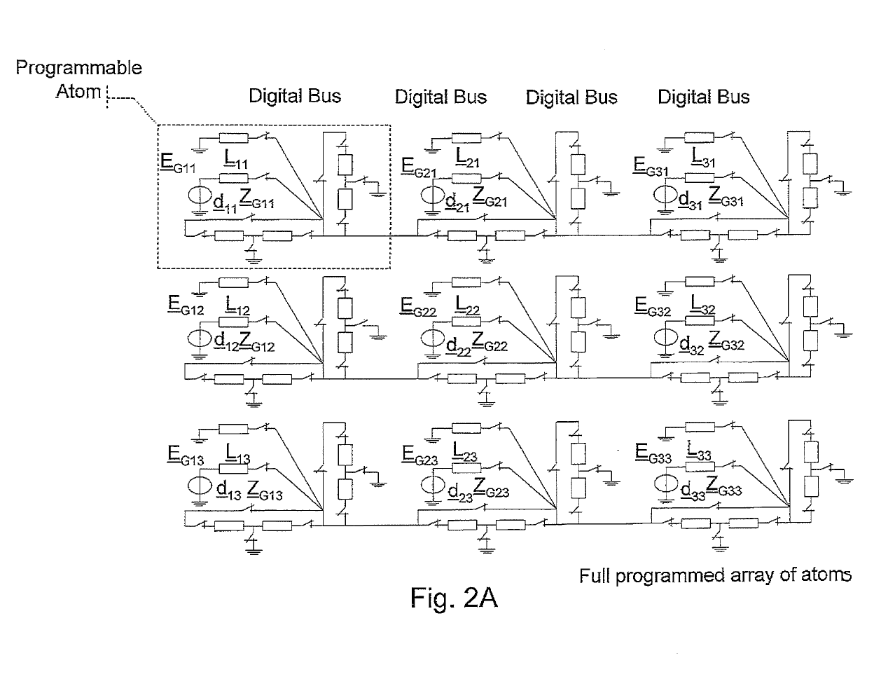

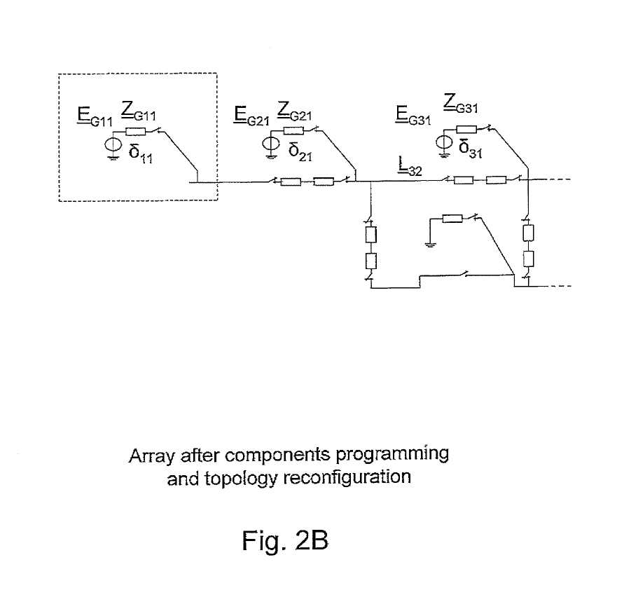

FIG. 2 shows an array 20 including a plurality of programmable elements 10 connected through an analog bus that represents the power grid of a power system. Further switches 18′ can be provided between programmable elements 10 within array 20 to enable the array 20 to assume any one of a plurality of selected topologies based on the selective operation of switches 18 and 18′. Programmable elements 10 within array 20 can also be reprogrammable, i.e. can be programmed to a selected power system topology and then repeatedly reprogrammed as desired to alternative power system topologies.

The connection of the plurality of programmable elements 10 within array 20 by means of an analog bus allows waveforms to propagate throughout the array 20 in real time. Such connection can allow an intrinsically concurrent communication approach, which has the advantage of avoiding the bottleneck effect observed when using an inherently sequential digital bus. Thus, the speed of data transmission between programmable elements 10 can be improved, and the mapping between real power system topologies and the emulated electronic representation of the power system can be facilitated.

Starting with the current steady state of the power system, the programmable elements 10 within array 20 can be programmed to a representative topology by selection operation of switches 18, 18′ within programmable elements 10 and within array 20, respectively.

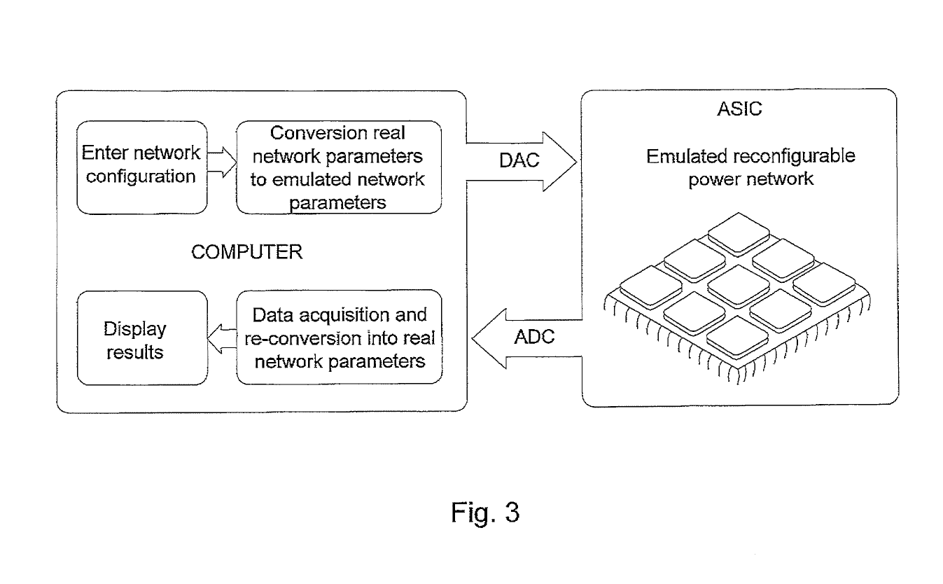

Digital to analog (D/A) conversion can be performed in order to program the components with programmable elements 10 and configure the overall topology of array 20. Analog to digital (A/D) conversion can also be performed to measure the system behavior, i.e. the emulation results. This is illustrated in FIG. 3.

FIG. 3 shows a selected network configuration, i.e. power system configuration, at step A, which requires emulation. A desired topology can be determined based on the real power system parameters to be emulated (step B). Digital to analog conversion then takes place (step C) to provide an emulated reconfigurable power network in the form of a programmed array 20 of programmed elements 10 by selective operation of switches 18, 18′ (step C). This emulated power network can then be configured to introduce selected altered parameters to reflect, for example, real power system disruption events or the like. Analog to digital conversion (step D) can then be performed to convert the data acquired from the emulated power system into real network parameters, and the results can be displayed to show the effect on a real power network of the emulated power system disruption.

It will be appreciated that, depending on the number of available programmable elements 10 within an array 20, a given array 10 can be used to map more than one topology. This enables parallel emulation that facilitates faster emulation speed using a single array 20.

Furthermore, through the use of an analog bus, the emulation speed can be substantially independent of the number of programmable elements 10 within the array 20 due to the concurrent communication approach facilitated by the analog bus, in contrast to the sequential approach of a digital bus.

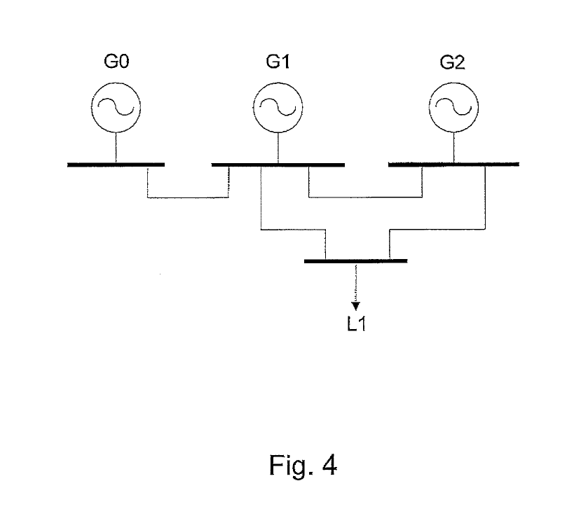

FIG. 4 shows a simple reference topology in order to demonstrate the reprogrammable nature of the array topology. The topology shown in FIG. 4 includes three generators 14 connected to one load 12.

The topology shown in FIG. 4 is accommodated in a single array 20 of programmable elements 10 presented on a printed circuit board 22. This printed circuit board 22 can be accommodated within an overall system of four printed circuit boards including two programmable generator boards and one board containing the emulated power system and load. The power system can be emulated by two purely resistive and equal networks, whereas the load can be emulated as a constant current source. The fourth printed circuit board can be used for interconnected purposes and power supply. The suitable parameters and scenarios can be set through a graphical computer interface; and the desired array topology can then be programmed via a digital interface such as, but not limited to, USB.

A microcontroller (e.g. a computer processor, executing computer-readable instructions recorded on a computer-readable recording medium, such as a non-volatile memory, which can include, for example, a read-only memory (ROM), a hard disk, a flash memory, an optical memory, etc.) can be used for sine and cosine computation as well as for the calibration of the components and dynamic compensation of the loop offset. The speed of the chosen A/D and D/A converters connected to the microcontroller(s) can determine the limitation of the time scaling factor ψ=dt_{powerworld}/dtₑₘᵤₗₐₜₒᵣ. It becomes possible to link the real power world and the analog emulation using the scaling factors ψ. For this implementation, the time scaling factor can be equal to ψ=100.

Results Comparison—Simulation Versus Emulation

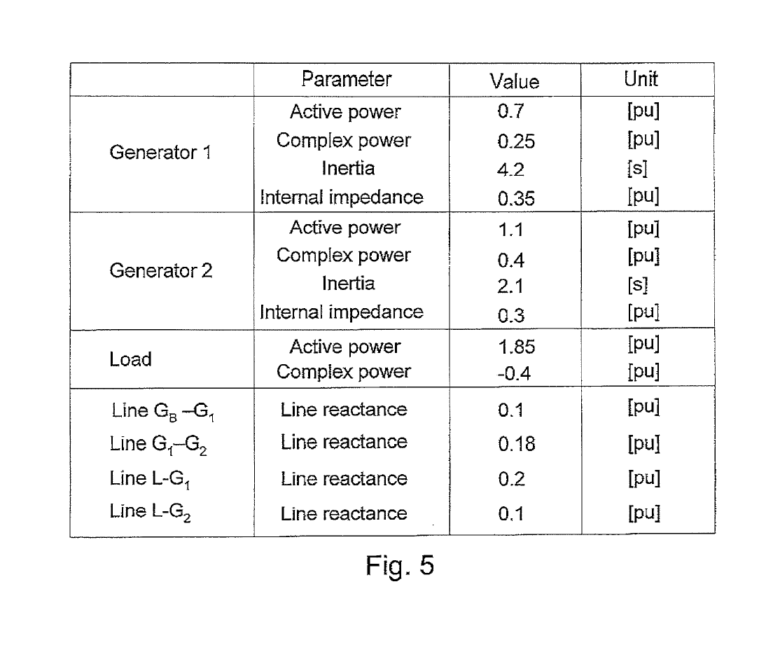

Numerical simulation and mixed signal measurements emulation results can be compared using the reference topology with a typical scenario. A reference simulator based on numerical algorithms has been realized using Labview in order to compare numerical simulation and mixed signal emulation approach. FIG. 5 shows the characteristics of the described power system.

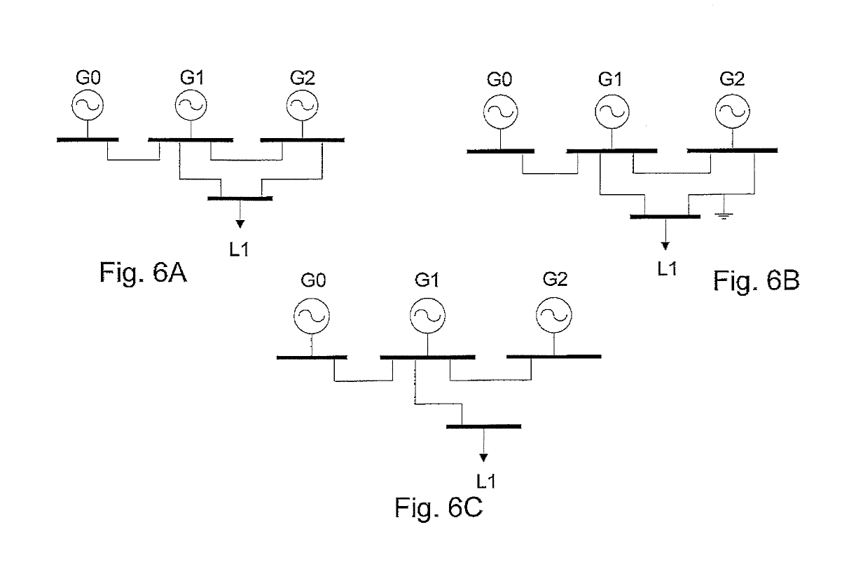

FIGS. 6A to C show a scenario applied to a reference topology. FIG. 6A shows a stationary state power system topology using the values computed through load flow. FIG. 6B shows a three phase short-circuit between generator G2 and load L1 in the middle of this transmission line. FIG. 6C shows disconnection of the short-circuited transmission line after a certain period of time.

According to an exemplary embodiment, two or more different comparisons can be performed in order to validate the DC emulation approach.

For example, the behavior of the electrical angle δ of the emulated generators can be validated (see FIG. 6). In the example of FIG. 6, the time scale shows that ψ=100, where δ is the rotor angle with respect to a voltage and phase reference and ψ is the time ratio between the emulated time and the real time.

As another example, it can be evaluated whether if the information of the critical short-circuit clearing time is viable, as shown in the example of FIG. 8.

Before emulation, the generator and load model circuitry can be calibrated, and the offset can be compensated in order to make it possible to meet with precision the results of numerical simulation. Both of the above comparisons show that mixed signal emulation can be an excellent trade-off for transient stability computation in terms of speed, precision and facility of calibration.

It will be appreciated that two or more programmable arrays can communicate between each other by different communication systems.

Although aspects of the present disclosure have been described with reference to the exemplary embodiments shown in the accompanying drawings, it is to be understood that the disclosure is not limited to the precise embodiments shown, and that various changes and modifications may be effected without further inventive skill and effort. For example, it will be appreciated that the present disclosure may be applied to various aspects of real time power systems including real time power system dynamic security assessments, robustness detection and improvement of global power system steady state, detection of critical short circuit clearing time, power system restoration, stability problem prediction with solution proposal, and microgrids.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Apparatus for emulation of a power system, the apparatus comprising:
a plurality of programmable elements which are selectively connectable to one another each programmable element comprising:
at least two elements selected from the group consisting of a generator element, a line element and a load element; and
a programmable switch element, operable to selectively connect the at least two elements of each programmable element to one another, and to selectively connect the programmable element to one or more other programmable elements.

2. Apparatus according to claim 1, wherein at least one programmable element comprises:
a generator element; and
a line element; and
wherein another programmable element comprises:
a load element; and
a line element.

3. Apparatus for emulation of a power system, the apparatus, comprising:
a plurality of programmable elements which are selectively connectable to one another, each programmable element comprising:
a programmable generator element;
a programmable line element;
a programmable load element; and
a programmable switch element operable to selectively connect the generator element, the line element and the load element, and to selectively connect the programmable element to one or more other programmable elements.

4. Apparatus according to claim 1, wherein the programmable switch element is operable to alter selectively the connections between said plurality of programmable elements.

5. Apparatus according to claim 3, wherein the programmable switch element is operable to alter selectively the connections between the generator element, the transmission line element and the load element of each programmable element.

6. Apparatus according to claim 1, wherein the programmable switch element comprises one or more selectable switches.

7. Apparatus according to claim 1, wherein the plurality of programmable elements are provided on an application specific integrated circuit (ASIC).

8. Apparatus according to claim 1, wherein the plurality of programmable elements are provided for a field programmable gate array

9. Apparatus according to claim 8, wherein the programmable gate array is at least one of an analog gate array and a digital gate array.

10. Apparatus according to claim 1, wherein the plurality of programmable elements is provided as an array.

11. Apparatus according to claim 10 comprising two or more arrays in communication with one another.

12. A system for emulating a power system, comprising:
an apparatus as claimed in claim 1; and
a controller for receiving user inputs and operable to supply control signals to the apparatus based on received user inputs.

13. Apparatus according to claim 2, wherein the programmable switch element is operable to alter selectively the connections between said plurality of programmable elements.

14. Apparatus according to claim 3, wherein the programmable switch element is operable to alter selectively the connections between said plurality of programmable elements.

15. Apparatus according to claim 2, wherein the programmable switch element comprises one or more selectable switches.

16. Apparatus according to claim 3, wherein the programmable switch element comprises one or more selectable switches.

17. Apparatus according to claim 3, wherein the plurality of programmable elements are provided on an application specific integrated circuit (ASIC).

18. Apparatus according to claim 3, wherein the plurality of programmable elements are provided for a field programmable gate array.

19. Apparatus according to claim 18, wherein the programmable gate array is an analog gate array and/or a digital gate array.

20. A system for emulating a power system, comprising:
an apparatus as claimed in claim 3; and
a controller for receiving user inputs and operable to supply control signals to the apparatus based on received user inputs.

21. Apparatus according to claim 1, wherein the programmable switch element is operable to alter selectively the connections between the generator element, the line element and the load element of each programmable element.
